(19) United States
(12) Patent Application Publication
(10) Pub. No.: US 2025/0051241 A1
(43) Pub. Date: Feb. 13, 2025

(54) PLASMA-ASSISTED CERAMIC SINTERING DEVICE AND CERAMIC SINTERING METHOD

(71) Applicant: Tsinghua Shenzhen International Graduate School, Shenzhen (CN)

(72) Inventors: Xi-Lin Wang, Shenzhen (CN); Zi-Yang Yan, Shenzhen (CN); Ruo-Bing Zhang, Shenzhen (CN); Hong-Yang Zhou, Shenzhen (CN); Zhi-Dong Jia, Shenzhen (CN); Li-Ming Wang, Shenzhen (CN)

(21) Appl. No.: 18/722,564

(22) PCT Filed: Oct. 21, 2022
(86) PCT No.: PCT/CN2022/126623

§ 371 Date: Jun. 20, 2024

(30) Foreign Application Priority Data
Dec. 21, 2021 (CN) 202111573492.X

(51) Int. Cl. C04B 41/00

(52) U.S. Cl. CPC C04B 41/0054

(57) ABSTRACT

The application provides a plasma-assisted ceramic sintering device and method. The plasma-assisted ceramic sintering device includes an enclosed container receiving ceramic green body and defining a gas outlet. A plasma jet device includes a working power supply and a plasma generation chamber. The plasma generation chamber defines a gas input port, and a gas output port located in the enclosed container. The plasma generation chamber includes a working electrode having a first end and a second end. The first end electrically connects the working power supply, and the second end is adjacent to the gas output port. A gas output device connects the gas input port for inputting working gas into the plasma generation chamber. A power supply device can electrically connect and apply voltage to the ceramic green body, obtaining the ceramic by sintering. The sintering device of the application provides plasma-assisted sintering and optimizes properties of ceramic materials.

### FIELD

The subject matter herein generally relates to the field of ceramic material manufacturing, and more particularly, to a plasma-assisted ceramic sintering device and ceramic sintering method.

### BACKGROUND

Ceramic materials are widely used in the fields of electronics, chemical industries, aerospace, and medical treatment. Sintering is an important process in the preparation of the ceramic materials. The ceramic materials, which are prepared by high-temperature sintering, may have disadvantages such as large grain size and high energy consumption. Small grain size can improve the mechanical and electrical properties of the ceramic materials, and therefore, the preparation of high-performance ceramics has important practical significance.

### SUMMARY

To overcome the above shortcomings, a ceramic sintering device and ceramic sintering method are needed.

A first aspect of the present application provides a plasma-assisted ceramic sintering device, including:
an enclosed container for storing a ceramic green body, the enclosed container defining a gas outlet;
a plasma jet device including a working power supply and a plasma generation chamber, the plasma generation chamber defining a gas input port and a gas output port, the gas output port being located in the enclosed container, the plasma generation chamber further including a working electrode, the working electrode including a first end and a second end, the first end being electrically connected to the working power supply, and the second end being adjacent to the gas output port;
a gas output device connected to the gas input port and configured to introduce working gas into the plasma generation chamber;
a power supply device configured to electrically connected and apply voltage to the ceramic green body, thereby sintering the ceramic green body to obtain ceramics.

The plasma-assisted ceramic sintering device of the present application uses the working electrode to discharge and generate plasma in the working gas. The generated plasma can process the ceramic green body in the enclosed container to optimize the properties of the ceramics. The gas output device is connected to the plasma generation chamber through the gas input port. On the one hand, the output gas functions as the working gas for generating plasma, and on the other hand, the output gas can enter the enclosed container through the gas output port to provide sintering atmosphere for the ceramic green body. The waste gas can be discharged out from the gas outlet of the enclosed container. In addition, since the gas output port of the plasma generation chamber is located in the enclosed container, the generated plasma can enter the enclosed container to process the ceramic green body. The sintering device of the present application can provide plasma-assisted sintering, thereby optimizing the properties of the ceramic materials.

According to some embodiments of the present application, the plasma generation chamber is received in the enclosed container.

According to some embodiments of the present application, the working power supply is a high-frequency power supply. The working power supply can generate plasma.

According to some embodiments of the present application, the power supply device is a high-voltage AC power supply, which can provide current of different magnitudes as needed. The power supply device can apply voltage to the ceramic green body for sintering.

According to some embodiments of the present application, the power supply device includes a voltage measurement device and/or a current measurement device. The power supply device of the present application may only include the voltage measurement device, the current measurement device, or both the voltage measurement device and the current measurement device. The voltage measurement device may be exemplified by a voltage meter, and the current measurement device may be exemplified by an ammeter. The voltage and current measurement devices may be used to measure and control the voltage and current applied to the ceramic green body.

According to some embodiments of the present application, the plasma generation chamber is an organic glass tube.

According to some embodiments of the present application, the working electrode is a tungsten wire.

According to some embodiments of the present application, a position of the gas output port corresponds to a position of the ceramic green body, which allows the plasma output from the gas output port to be sprayed onto the surface of the ceramic green body for surface treatment.

According to some embodiments of the present application, the working gas is nitrogen or helium.

A second aspect of the present application provides a ceramic sintering method, including:
providing a ceramic green body;
spraying plasma from a plasma jet device onto a surface of the ceramic green body for surface treatment, applying voltage to the ceramic green body and gradually increasing the voltage to a target voltage, and maintaining a current density flowing through the ceramic green body during a preset period, thereby obtaining ceramics through sintering; or
applying voltage to the ceramic green body and gradually increasing the voltage to a target voltage, maintaining a current density flowing through the ceramic green body during a preset period, and spraying plasma generated by the plasma jet device onto the surface of the ceramic green body for surface treatment, thereby obtaining the ceramics through sintering.

The ceramic sintering method of the present application applies voltage to the ceramic green body and gradually increases the voltage to the target voltage. Discharge along dielectric surface of the ceramic green body occurs after the target voltage is achieved. Then, conductivity of the ceramic green body changes. After discharge along dielectric surface of the ceramic green body occurs, conductive channels can be formed inside the ceramic green body, and rapid sintering of ceramics can be achieved under Joule heating effect, thereby achieving achieve rapid densification of ceramic materials at room temperature. At the same time, the present application optimizes the properties of the ceramics by plasma-assisted sintering. The plasma can be applied during two stages. One stage is before the voltage applied to the ceramic green body is increased to the target voltage to initiate discharge along dielectric surface of the ceramic green body, wherein plasma is used to induce the discharge and to reduce the starting voltage of the flash sintering of the ceramics. Another stage is after the voltage is increased to the target voltage to change the conductivity of the ceramic green body, wherein plasma is used to process the surface of the ceramic, causing the ceramic green body to interact with active particles of the plasma at high temperatures during the sintering process, which can modify the surface of the ceramics and regulate the properties of the ceramics, thereby optimizing the properties of the ceramics.

According to some embodiments of the present application, a rate of voltage increase is 0.1 kV/s to 5 kV/s, and the current density flowing through the ceramic green body maintains at 10 mA/mm² to 150 mA/mm². When the rate of voltage increase is less than 0.1 kV/s, the sintering process is too slow, which is not conducive to the occurrence of flash sintering. When the rate of voltage increase is higher than 5 kV/s, the fast voltage increase may cause direct breakdown at both ends of the ceramic green body, thereby melting the wires connected to both ends of the ceramic green body. The current density flowing through the ceramic green body maintains at 10 mA/mm² to 150 mA/mm². A low current density cannot ensure rapid densification of the ceramic green body, and a high current density may cause rapid shrinkage, local overheating and fracture of the ceramics.

According to some embodiments of the present application, the target voltage is 3 kV to 4 kV. The gradually increased voltage, which can induce discharge along dielectric surface, is 3 kV to 4 kV under normal pressure. The conductivity of the ceramic green body changes to generate a current channel, and ceramics can be obtained after rapidly densifying and sintering. The target voltage is related to the length of the ceramic green body. When the voltage is increased to the target voltage, the current density flowing through the ceramic green body can be 10 mA/mm² to 150 mA/mm² by controlling the target voltage, which can achieve rapid densification of the ceramic green body.

According to some embodiments of the present application, the ceramic green body is connected to a power supply device by forming a first electrode and a second electrode on the ceramic green body, and connecting the first electrode and the second electrode to the power supply device.

According to some embodiments of the present application, the first electrode and the second electrode are made of gold or conductive silver paste. The electrodes can be formed on ceramic green body by spraying gold or applying conductive silver paste thereon, so that the ceramic green body can be electrically connected to the power supply device.

According to some embodiments of the present application, the ceramic green body is at least one of cylindrical, rectangular, or dog-bone-shaped.

### BRIEF DESCRIPTION OF THE DRAWINGS

FIG. 1 is a diagrammatic view of a plasma-assisted ceramic sintering device according to an embodiment of the present application.

FIG. 2 is a diagram showing voltages and currents in a ceramic sintering method according to a first embodiment of the present application, wherein plasma surface treatment has been performed on a ceramic green body.

FIG. 3 is a diagram showing voltages and currents in a ceramic sintering method according to comparative example of the present application, wherein no plasma surface treatment has been performed on the ceramic green body.

FIG. 4 is a scanning electron microscope (SEM) image of ceramic prepared by the ceramic sintering method according to a second embodiment of the present application, wherein a is the SEM image of ceramic prepared by plasma surface treatment and a flash sintering period of 90 seconds, b is the SEM image of ceramic prepared by a flash sintering time of 120 seconds but without plasma surface treatment without, c is the SEM image of ceramic prepared by a flash sintering time of 90 seconds but without plasma surface treatment, and d is the SEM image of ceramic prepared by a flash sintering time of 60 seconds but without plasma surface treatment.

### DESCRIPTION OF NUMERIC OF MAIN COMPONENT

enclosed container 100, gas outlet 110, plasma jet device 200, working power supply 210, plasma generation chamber 220, gas input port 221, gas output port 222, working electrode 230, first end 231, second end 232, gas output device 300, flowmeter 310, power supply device 400, voltage measurement device 410, current measurement device 420, ceramic green body 500.

The following implementation of the present application will be further explained with the drawings.

### DETAILED DESCRIPTION

Implementations of the disclosure will now be clearly and completely described, by way of embodiments only, with reference to the drawings. The disclosure is only a portion but not all of the embodiments of the present application. Changes made based on the embodiments of the present application in this application by one having ordinary skill in the art without creative work may be within the scope of the present application.

Unless otherwise defined, all technical terms used herein have the same meaning as commonly understood by one of ordinary skill in the art. The technical terms used herein are not to be considered as limiting the scope of the embodiments.

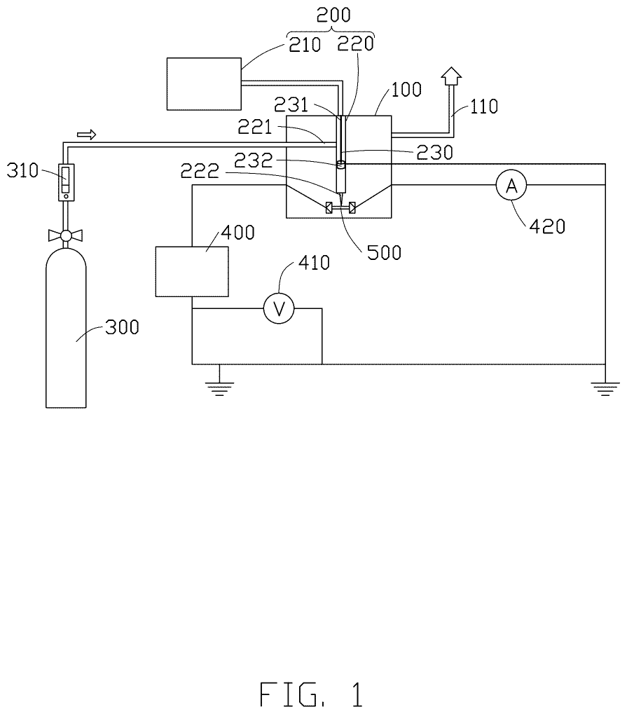

Referring to FIG. 1, a plasma-assisted ceramic sintering device according to an embodiment of the present application includes an enclosed container 100, a plasma jet device 200, a gas output device 300, and a power supply device 400. The enclosed container 100 can receive a ceramic green body 500 therein, and a gas outlet 110 is defined on the enclosed container 100. The plasma jet device 200 includes a working power supply 210 and a plasma generation chamber 220. The plasma generation chamber 220 defines a gas input port 221 and a gas output port 222. The gas output port 222 is located in the enclosed container 100, so that plasma or gas output from the gas output port 222 can enter the enclosed container 100 and process the ceramic green body 500 therein. In an embodiment, the plasma generation chamber 220 is received in the enclosed container 100. The plasma generation chamber 220 further includes a working electrode 230 therein. The working electrode 230 includes a first end 231 and a second end 232. The first end 231 is electrically connected to the working power supply 210, and the second end 232 is adjacent to the gas output port 222. The gas output device 300 is connected to the gas input port 221 of the plasma generation chamber 220 through a gas tube, and can input working gas into the plasma generation chamber 220. After connecting the working power supply 210, the working electrode 230 can discharge at the second end 232 to generate plasma with the assistance of the working gas. The generated plasma is output through the gas output port 222 and sprayed onto a surface of the ceramic green body 500. In addition, since the gas output port 222 is located in the enclosed container 100, the working gas output by the gas output device 300 can also be output to the enclosed container 100 through the gas output port 222 to provide a sintering atmosphere. Any waste gas generated by the sintering process can be discharged out through the gas outlet 110 of the enclosed container 100. The power supply device 400 can be electrically connected to the ceramic green body 500, and can apply voltage and current onto the ceramic green body 500. In use, the power supply device 400 is electrically connected to the ceramic green body 500, which can gradually increase the voltage applied onto the ceramic green body 500 until discharge along dielectric surface or inside the ceramic green body 500 occurs. Then, conductivity of the ceramic green body 500 changes. Furthermore, by controlling the current density through the ceramic green body 500, and ceramic with a certain density can be obtained by a flash sintering method. The plasma generated by the plasma jet device 200 can assist in the sintering process of the ceramics to optimize the properties of the ceramic. The plasma can be applied during two stages. One stage is before discharge along dielectric surface of the ceramic green body 500 occurs, wherein plasma is generated after the working power supply 210 is turned on, and the plasma can induce the discharge of the ceramic green body 500, thereby reducing the starting voltage of the flash sintering of the ceramic. Another stage is the sintering stage after the conductivity of the ceramic green body 500 changes, wherein plasma is generated after the working power supply 210 is turned on, and the generated plasma is sprayed on the surface of the ceramic to regulate the properties of the ceramic.

In some embodiments, the power supply device 400 includes a voltage measurement device 410 and a current measurement device 420. The voltage measurement device 410 can measure and control the voltage applied onto the ceramic green body 500. The current measurement device 420 can measure the current flowing through the ceramic green body 500. By controlling the voltage applied onto the ceramic green body 500 and the current flowing through the ceramic green body 500, the ceramic green body 500 can be formed after the flash sintering process, thereby achieving rapid densification of the ceramic.

In some embodiments, the plasma generation chamber 220 is an organic glass tube, and the working electrode 230 is a tungsten wire.

In some embodiments, the working gas output by the gas output device 300 is nitrogen or helium, which can generate plasma and provide the gas atmosphere in the enclosed container 100.

In some embodiments, a flowmeter 310 is connected to the gas output device 300, and can control the flow rate of the working gas.

In some embodiments, a position of the gas output port 222 corresponds to a position of the ceramic green body 500, so that the generated plasma can be sprayed onto the surface of the ceramic green body 500 from the gas output port 222. For example, the position of the gas output port 222 can be above the ceramic green body 500, and the plasma can be sprayed from the upper position of the ceramic green body 500.

A first embodiment of the present application further provides a ceramic sintering method using the plasma-assisted ceramic sintering device mentioned above. The ceramic sintering method includes the following steps.

Step S1, the ceramic green body is provided.

In some embodiments, the ceramic green body can be prepared by selecting zinc oxide powders, which are subjected to processes such as ball milling, drying, granulation, sieving, pressing, and calcination to remove binders, thereby obtaining the ceramic green body 500 that can be used for subsequent processes. High-temperature silver paste is applied onto two sides of the ceramic green body and dried at an appropriate temperature to form the first and second electrodes. The ceramic green body is substantially in a shape of dog bone. The dog bone has an overall length of 21 mm, and an overall width of 3.3 mm, and a thickness of the middle area of the dog bone is 1.7 mm.

Step S2, the ceramic green body 500 is placed into the enclosed container 100. Wires are wrapped around the first and second electrodes at both ends of the ceramic green body 500, the wires electrically connect two ends of the ceramic green body 500 to the power supply device 400. Then, the wires are fixed on a fixing bracket to suspend the ceramic green body 500. The power supply device 400 is a high-voltage AC power supply, and the power supply device 400 remains in a power-off state.

Step S3, plasma is generated by the plasma jet device, which can be carried out by opening a value of the gas output device 300, adjusting the flowmeter 310 to output the working gas with a volume flow rate of 10 L/min. Then, the working power supply 210 is turned on, and the working electrode 230 discharges with the assistance of the working gas to generate stable plasma. The generated plasma is sprayed onto the surface of the ceramic green body 500 for surface treatment. In an embodiment, the gas output device 300 is a nitrogen gas cylinder, and the working power supply 210 is a high-frequency power supply.

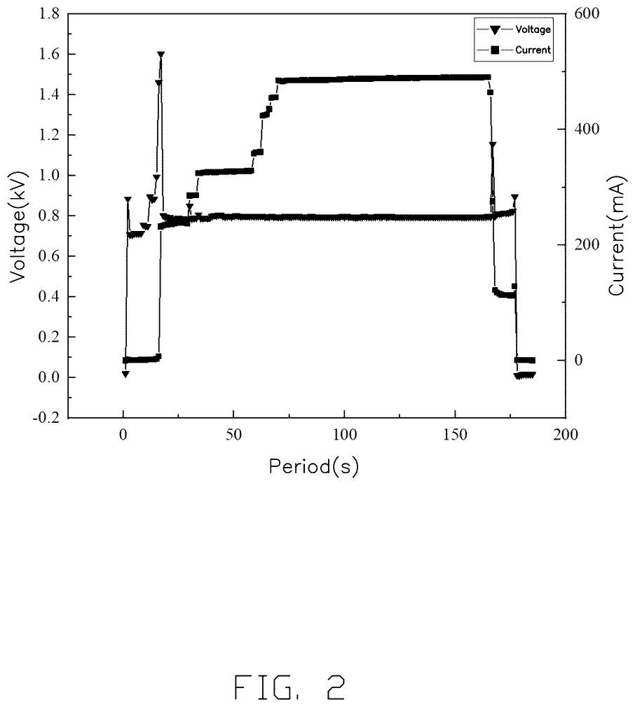

Step S4, the plasma is stopped after 30 minutes of plasma treatment, and the power supply device 400 is turned on. The voltage is generally increased to a target voltage at a rate of 0.2 kV/s, causing discharge along dielectric surface of the ceramic green body 500 to occur. The voltage at this time is recorded as a starting voltage for flash sintering. Afterwards, the voltage at both ends of the ceramic suddenly drops, and the current instantly increases. Then, the current density maintains within a preset range, and a stable conductive channel is generated inside the green body to initiate a stable sintering stage. After a preset sintering period (such as 1 minute), the power supply is disconnected, and experimental data including the voltage and current are recorded and shown in FIG. 2.

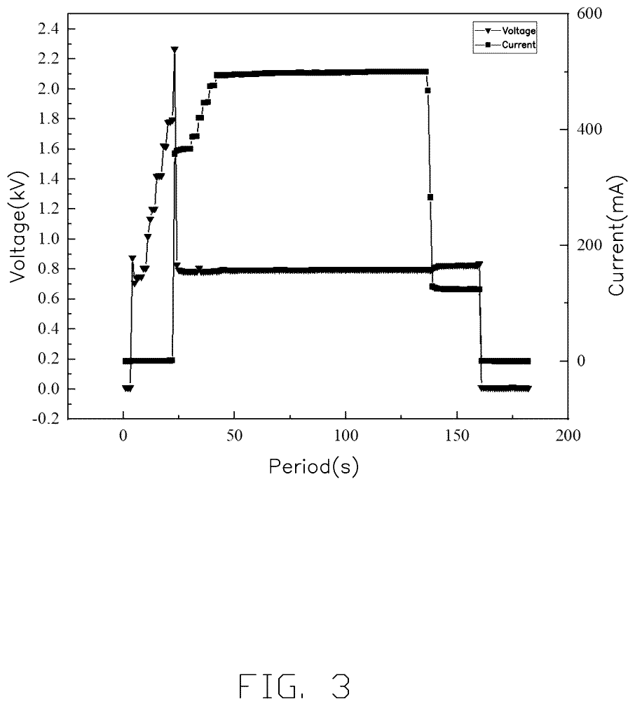

Step S5, the working power supply 210 is turned off, and steps S2 and S4 are repeated on a new ceramic green body to obtain another set of comparison experimental data including the voltages and currents. The comparison experimental data including the voltages and currents is shown in FIG. 3. That is, no plasma surface treatment is performed on the ceramic green body 500, and the ceramic green body 500 directly undergoes a flash sintering to obtain the set of comparative experimental data. Compared FIG. 2 with FIG. 3, the starting voltage of the ceramic flash sintering is by providing plasma before the discharge along dielectric surface occurs on the ceramic green body.

A second embodiment of the present application further provides a ceramic sintering process using the above-mentioned plasma-assisted ceramic sintering device.

Step S1, the ceramic green body 500 is provided.

In some implementation methods, ceramic green body can be prepared in the embodiment by selecting zinc oxide powders, which are subjected to processes such as ball milling, drying, granulation, sieving, pressing, and calcination to remove binders, thereby obtaining the ceramic green body 500 that can be used for subsequent processes. High-temperature silver paste is applied onto two sides of the ceramic green body 500 and dried at an appropriate temperature to form the first and second electrodes. The ceramic green body is substantially in a shape of dog bone. The dog bone has an overall length of 21 mm, and an overall width of 3.3 mm, and a thickness of the middle area of the dog bone is 1.7 mm.

Step S2, the ceramic green body 500 is placed into the enclosed container 100. Wires are wrapped around the first and second electrodes at both ends of the ceramic green body 500, the wires electrically connect two ends of the ceramic green body 500 to the power supply device 400. Then, the wires are fixed on a fixing bracket to suspend the ceramic green body 500. The power supply device 400 is a high-voltage AC power supply, and the power supply device 400 remains in a power-off state.

Step S3, the power supply device 400 is turned on. The voltage is generally increased to a target voltage at a rate of 0.2 kV/s, causing discharge along dielectric surface of the ceramic green body 500 to occur. The voltage at this time is recorded as a starting voltage for flash sintering. Afterwards, the voltage at both ends of the ceramic suddenly drops, and the current instantly increases. Then, the current density maintains within a preset range, and a stable conductive channel is generated inside the green body to initiate a stable sintering stage.

Step S4, plasma is generated by the plasma jet device, which can be carried out by opening a value of the gas output device 300, adjusting the flowmeter 310 to output the working gas with a volume flow rate of 10 L/min. Then, the working power supply 210 is turned on, and the working electrode 230 discharges with the assistance of the working gas to generate stable plasma. The generated plasma is sprayed onto the surface of the ceramic green body 500 for surface treatment. In an embodiment, the gas output device 300 is a nitrogen gas cylinder, and the working power supply 210 is a high-frequency power supply.

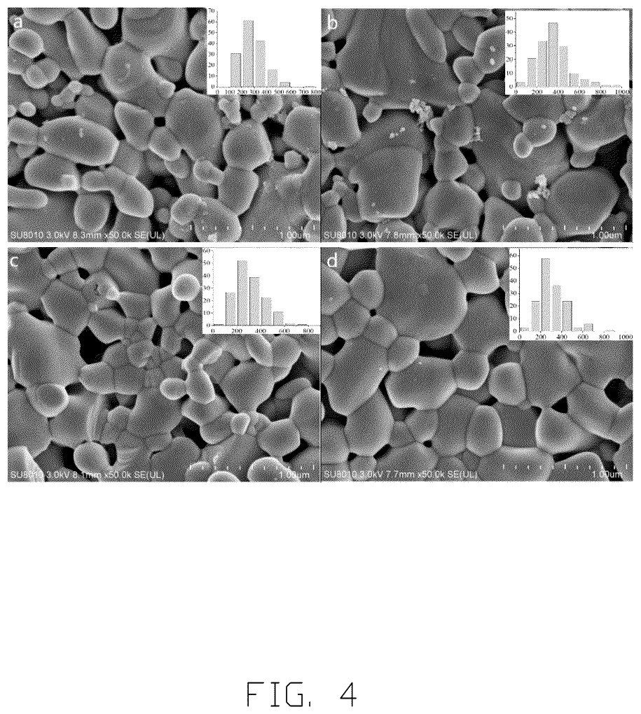

Step S5, the power supply device 400 is disconnected when the sintering process lasts for 1 minute. In the second embodiment, the flash sintering period of the ceramic green body is 90 seconds, and the electron microscope scanning image of the obtained ceramic sample is shown in a of FIG. 4. For the ceramic samples prepared by the same steps S1, S2, S3, and S5 of the second embodiment without plasma surface treatment, electron microscopy scanning test is also performed on the ceramic sample. The electron microscope scanning image of the ceramic sample prepared with a flash sintering time of 120 seconds is shown in b of FIG. 4, the electron microscope scanning image of the ceramic sample prepared with a flash sintering time of 90 seconds is shown in c of FIG. 4, and the electron microscope scanning image of the ceramic sample prepared with a flash sintering time of 60 seconds is shown in d of FIG. 4. According to FIG. 4, after the plasma treatment, the grain size of the ceramic sample decreases, and the grain size distribution has a higher concentration.

The experimental results of the second embodiment show that when plasma is applied after the ceramic green body enters the stable sintering stage, the ceramic green body and the active particles in the plasma can interact with each other at high temperature, thereby allowing the grain size distribution to be more uniform and reducing the grain size. Thus, the properties of the ceramic can be optimized.

In some embodiments, the rate of voltage increase during the sintering process is 0.1 kV/s to 5 kV/s. By adjusting the rate of voltage increase and further controlling the current density flowing through the ceramic green body 500 to be 10 mA/mm² to 150 mA/mm², ceramics with different densities can be obtained after the flash sintering process.

The embodiments shown and described above are only examples. Therefore, many commonly-known features and details are neither shown nor described. Even though numerous characteristics and advantages of the present technology have been set forth in the foregoing description, together with details of the structure and function of the present application, the disclosure is illustrative only, and changes may be made in the detail, including in matters of shape, size, and arrangement of the parts within the principles of the present application, up to and including the full extent established by the broad general meaning of the terms used in the claims. It will, therefore, be appreciated that the embodiments described above may be modified within the scope of the claims.

1. A plasma-assisted ceramic sintering device comprising:
an enclosed container for storing a ceramic green body, the enclosed container defining a gas outlet;
a plasma jet device comprising a working power supply and a plasma generation chamber, wherein the plasma generation chamber defines a gas input port and a gas output port, the gas output port is located in the enclosed container, the plasma generation chamber further comprises a working electrode, the working electrode comprises a first end and a second end, the first end is electrically connected to the working power supply, and the second end is adjacent to the gas output port;
a gas output device connected to the gas input port and configured to introduce working gas into the plasma generation chamber; and
a power supply device configured to electrically connected and to apply voltage to the ceramic green body, thereby sintering the ceramic green body to obtain ceramics.

2. The plasma-assisted ceramic sintering device according to claim 1, wherein the power supply device comprises a voltage measurement device and/or a current measurement device.

3. The plasma-assisted ceramic sintering device according to claim 1, wherein the plasma generation chamber is an organic glass tube.

4. The plasma-assisted ceramic sintering device according to claim 1, wherein the working electrode is a tungsten wire.

5. The plasma-assisted ceramic sintering device according to claim 1, wherein a position of the gas output port corresponds to a position of the ceramic green body.

6. The plasma-assisted ceramic sintering device according to claim 1, wherein the working gas is nitrogen or helium.

7. A ceramic sintering method comprising:
providing a ceramic green body;
spraying plasma from a plasma jet device onto a surface of the ceramic green body for surface treatment; and
applying voltage to the ceramic green body and gradually increasing the voltage to a target voltage, and maintaining a current density flowing through the ceramic green body during a preset period, thereby obtaining ceramics through sintering.

8. The ceramic sintering method according to claim 7, wherein a rate of voltage increase is 0.1 kV/s to 5 kV/s, and the current density flowing through the ceramic green body maintains at 10 mA/mm² to 150 mA/mm².

9. The ceramic sintering method according to claim 7, wherein the target voltage is 3 kV to 4 kV.

10. The ceramic sintering method according to claim 7, wherein the ceramic green body is connected to a power supply device by forming a first electrode and a second electrode on the ceramic green body, and connecting the first electrode and the second electrode to the power supply device.

11. A ceramic sintering method comprising:
providing a ceramic green body;
applying voltage to the ceramic green body and gradually increasing the voltage to a target voltage, and maintaining a current density flowing through the ceramic green body during a preset period; and
spraying plasma from a plasma jet device onto a surface of the ceramic green body for surface treatment, thereby obtaining the ceramics through sintering.

12. The ceramic sintering method according to claim 11, wherein a rate of voltage increase is 0.1 kV/s to 5 kV/s, and the current density flowing through the ceramic green body maintains at 10 mA/mm² to 150 mA/mm².

13. The ceramic sintering method according to claim 11, wherein the target voltage is 3 kV to 4 kV.

14. The ceramic sintering method according to claim 11, wherein the ceramic green body is connected to a power supply device by forming a first electrode and a second electrode on the ceramic green body, and connecting the first electrode and the second electrode to the power supply device.
